(19) United States
(12) Patent Application Publication
(10) Pub. No.: US 2019/0042473 A1
(43) Pub. Date: Feb. 7, 2019

(54) TECHNOLOGIES FOR ENABLING SLOW SPEED CONTROLLERS TO USE HW CRYPTO ENGINE FOR I/O PROTECTION

(71) Applicant: Intel Corporation, Santa Clara, CA (US)

(72) Inventors: Rajesh Bhaskar, Bangalore (IN); Reshma Lal, Hillsboro, OR (US); Siddhartha Chhabra, Portland, OR (US)

(21) Appl. No.: 15/856,570

(22) Filed: Dec. 28, 2017

(51) Int. Cl. G06F 12/14; G06F 21/78; G06F 21/85; G06F 21/60; G06F 13/28

(52) U.S. Cl. CPC G06F 12/1408; G06F 21/78; G06F 2212/1052; G06F 21/602; G06F 13/28; G06F 21/85

(57) ABSTRACT

Technologies for secure I/O include a computing device that further includes an I/O controller and a trusted I/O (TIO) mode manager. The TIO mode manager is to program, over a secure routing hardware of the computing device, the I/O controller of the computing device to allow or disallow trusted I/O. The I/O controller is to disable accesses to memory regions associated with one or more programmable I/O registers of an I/O controller of the computing device in response to programming the I/O controller to allow trusted I/O; perform I/O data transfers to or from an I/O device via direct memory access in response to disabling the accesses to the memory regions associated with the one or more programmable I/O registers, wherein the I/O data transfers are protected by a trusted I/O channel; and enable accesses to the address regions associated with the one or more programmable I/O registers in response to programming the I/O controller to disallow trusted I/O.

### BACKGROUND

Trusted I/O (TIO) technology enables an application to send and/or receive I/O data securely to/from a device. In addition to the hardware that produces or consumes the I/O data, several software and firmware components in the I/O pipeline might also process the data. Slow speed I/O controllers, such as an inter-integrated circuit (I2C), a serial peripheral interface (SPI), and a universal asynchronous receiver-transmitter (UART), that allow I/O data transfers to or from I/O devices via direct memory access (DMA) may use a hardware cryptographic engine to protect I/O. For example, HCTIO (Hardware Cryptography-based Trusted I/O) is a technology that provides cryptographic protection of DMA data via an inline Crypto Engine (CE) in the system-on-a-chip (SoC). Channel ID (CID), an identifier, uniquely identifies a DMA channel on the platform, and the CE filters DMA traffic and encrypts select I/O transactions upon a match with the CID programmed in the CE. Certain devices may provide trusted I/O using an inline CID filter in the SoC and a processor-based Crypto Engine (e.g., using microcode or other processor resources). However, certain slow speed I/O controllers may also allow I/O data transfers via programmable I/O (PIO), which enable software to read directly from or write directly into PIO registers of the I/O controller.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a computing device for secure I/O;

FIG. 2 is a simplified block diagram of at least one embodiment of an environment of the computing device of FIG. 1; and

FIGS. 3-5 are a simplified flow diagram of at least one embodiment of a method for enabling an I/O controller to securely transfer I/O data that may be performed by the computing device of FIGS. 1 and 2.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

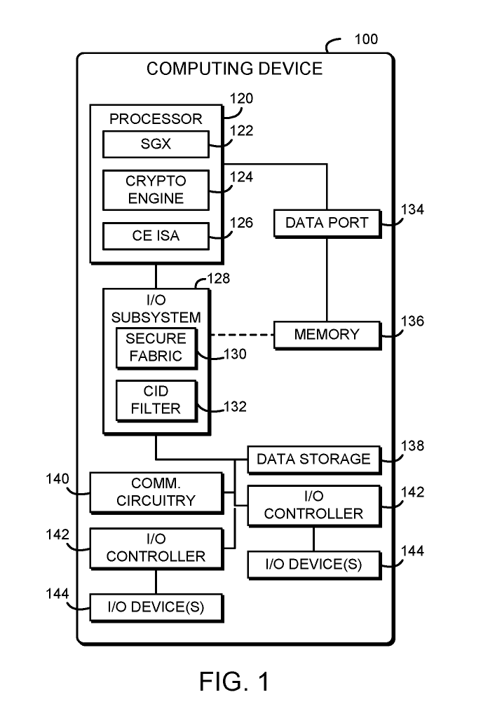

Referring now to FIG. 1, an illustrative computing device 100 for secure input/output (I/O) is shown. In use, as described further below, the computing device 100 may program an I/O controller 142 of the computing device 100 to allow trusted I/O (TIO) over secure routing hardware of the computing device 100. The secure routing hardware only allows microcode of a processor 120 of the computing device 100 to access the I/O controller 142 to set or clear a TIO enable register of the I/O controller 142 to allow trusted I/O. Additionally, the I/O controller 142 may drop any unauthorized requests to set or clear the TIO enable register. By doing so, the computing device 100 may protect the I/O data from modification by untrusted software. In response to programming the I/O controller to allow the trusted I/O, the I/O controller 142 may disable accesses to memory regions of a memory 136 of the computing device 100 associated with one or more programmable I/O (PIO) registers of the I/O controller. For example, the one or more PIO registers may include any register that allows access to plaintext I/O data to or from an I/O device. It should be appreciated that certain other PIO registers, such as a PIO register that is responsible for enabling a power save mode, may not be disabled. Once the PIO registers are disabled to allow the trusted I/O, the I/O controller 142 may perform I/O data transfers to or from an I/O device via only direct memory access (DMA), and not via programmable I/O (PIO), over the secure routing hardware. As such, the computing device 100 may encrypt and/or decrypt DMA I/O data input from and/or output to one or more I/O devices 144. Because the memory region associated with the TIO enable register is protected by hardware routing support, even privileged software such as an untrusted operating system may be prevented from modifying the TIO mode. Accordingly, the computing device 100 may improve I/O controller security, for example by preventing untrusted software from modifying the TIO mode to gain access to certain I/O devices.

The computing device 100 may be embodied as any type of device capable of performing the functions described herein. For example, the computing device 100 may be embodied as, without limitation, a computer, a laptop computer, a tablet computer, a notebook computer, a mobile computing device, a smartphone, a wearable computing device, a multiprocessor system, a server, a workstation, and/or a consumer electronic device. As shown in FIG. 1, the illustrative computing device 100 includes the processor 120, an I/O subsystem 128, the memory 136, a data storage device 138, and one or more I/O controllers 142. Additionally, in some embodiments, one or more of the illustrative components may be incorporated in, or otherwise form a portion of, another component. For example, the memory 136, or portions thereof, may be incorporated in the processor 120 in some embodiments.

The processor 120 may be embodied as any type of processor capable of performing the functions described herein. For example, the processor 120 may be embodied as a single or multi-core processor(s), digital signal processor, microcontroller, or other processor or processing/controlling circuit. As shown, the processor 120 illustratively includes secure enclave support 122, a cryptographic engine 124, and a cryptographic engine instruction set architecture (ISA) 126. The secure enclave support 122 allows the processor 120 to establish a trusted execution environment known as a secure enclave, in which executing code may be measured, verified, and/or otherwise determined to be authentic. Additionally, code and data included in the secure enclave may be encrypted or otherwise protected from being accessed by code executing outside of the secure enclave. For example, code and data included in the secure enclave may be protected by hardware protection mechanisms of the processor 120 while being executed or while being stored in certain protected cache memory of the processor 120. The code and data included in the secure enclave may be encrypted when stored in a shared cache or the main memory 136. The secure enclave support 122 may be embodied as a set of processor instruction extensions that allows the processor 120 to establish one or more secure enclaves in the memory 136. For example, the secure enclave support 122 may be embodied as Intel® Software Guard Extensions (SGX) technology.

The cryptographic engine 124 may be embodied as one or more hardware functional blocks (IP blocks), microcode, or other resources of the processor 120 that allows the processor 120 to perform trusted I/O (TIO) functions. For example, as described further below, the cryptographic engine 124 may perform TIO functions such as encrypting and/or decrypting direct memory access (DMA) I/O data input from and/or output to one or more I/O devices 144. In particular, in some embodiments, plaintext I/O data may be stored in a TIO Processor Reserved Memory (TIO PRM) region that is not accessible to software of the computing device 100, and the cryptographic engine 124 may be used to encrypt the plaintext DMA I/O data and copy the encrypted data to an ordinary kernel I/O buffer. The processor 120 may also include one or more range registers or other features to protect the TIO PRM from unauthorized access.

The cryptographic engine ISA 126 may be embodied as one or more processor instructions, model-specific registers, or other processor features that allows software executed by the processor 120 to securely program and otherwise use the cryptographic engine 124 and a corresponding channel ID (CID) filter 132, described further below. For example, the cryptographic engine ISA 126 may include processor features to bind programming instructions to the cryptographic engine 124 and/or the CID filter 132, unwrap bound programming instructions, securely clean the TIO PRM region of the memory 136, and/or securely copy and encrypt data from the TIO PRM region to a kernel I/O buffer.

The memory 136 may be embodied as any type of volatile or non-volatile memory or data storage capable of performing the functions described herein. In operation, the memory 136 may store various data and software used during operation of the computing device 100 such as operating systems, applications, programs, libraries, and drivers. Further, the memory 136 may also include the TIO PRM region. The memory 136 is illustratively connected with a data port 134 to send and receive data from the processor 120 and the I/O subsystem 128. Additionally or alternatively, in some embodiments, the memory 136 may be communicatively coupled to the processor 120 via the I/O subsystem 128.

The I/O subsystem 128 may be embodied as circuitry and/or components to facilitate input/output operations with the processor 120, the memory 136, and other components of the computing device 100. For example, the I/O subsystem 128 may be embodied as, or otherwise include, memory controller hubs, input/output control hubs, sensor hubs, host controllers, firmware devices, communication links (i.e., point-to-point links, bus links, wires, cables, light guides, printed circuit board traces, etc.) and/or other components and subsystems to facilitate the input/output operations. In some embodiments, the memory 136 may be directly coupled to the processor 120, for example via an integrated memory controller hub. The I/O subsystem 128 may further include a secure fabric 130. The secure fabric 130 provides secure routing support, which may include hardware support to ensure I/O data cannot be misrouted in the I/O subsystem 128 under the influence of rogue software. As described further below, the secure fabric 130 may be used with the CID filter 132 to provide cryptographic protection of I/O data. Additionally, in some embodiments, the I/O subsystem 128 may form a portion of a system-on-a-chip (SoC) and be incorporated, along with the processor 120, the memory 136, and other components of the computing device 100, on a single integrated circuit chip. Additionally or alternatively, in some embodiments the processor 120 may include an integrated memory controller and a system agent, which may be embodied as a logic block in which data traffic from processor cores and I/O devices converges before being sent to the memory 136.

The data storage device 138 may be embodied as any type of device or devices configured for short-term or long-term storage of data such as, for example, memory devices and circuits, memory cards, hard disk drives, solid-state drives, non-volatile flash memory, or other data storage devices. The computing device 100 may also include a communications subsystem 140, which may be embodied as any communication circuit, device, or collection thereof, capable of enabling communications between the computing device 100 and other remote devices over a computer network (not shown). The communications subsystem 140 may be configured to use any one or more communication technology (e.g., wired or wireless communications) and associated protocols (e.g., Ethernet, Bluetooth®, Wi-Fi®, WiMAX, 3G, 4G LTE, etc.) to effect such communication.

The CID filter 132 may be embodied as any hardware component, functional block, logic, or other circuit that performs CID filtering function(s), including filtering I/O transactions based on CIDs inserted by the I/O controllers 142. For example, the CID filter 132 may observe DMA transactions inline, perform test(s) based on the CID and memory address included in the transaction, and drop transactions that fail the test(s). In the illustrative embodiment, the CID filter 132 is incorporated in the I/O subsystem 128. In other embodiments, the CID filter 132 may be included in one or more other components and/or in an SoC with the processor 120 and I/O subsystem 128 as a separate component.

Each of the I/O controllers 142 may be embodied as any inter-integrated circuit (I2C) controller, serial peripheral interface (SPI) controller, universal asynchronous receiver-transmitter (UART) controller, embedded controller, microcontroller, microprocessor, functional block, logic, or other circuit or collection of circuits capable of performing the functions described herein. In some embodiments, one or more of the I/O controllers 142 may be embedded in another component of the computing device 100 such as the I/O subsystem 128 and/or the processor 120. Additionally or alternatively, one or more of the I/O controllers 142 may be connected to the I/O subsystem 128 and/or the processor 120 via an expansion bus such as PCI Express (PCIe) or other I/O connection. As described above, the I/O controllers 142 communicate with one or more I/O devices 144, for example over a peripheral communications bus (e.g., I2C, SPI, serial communications, etc.).

The I/O devices 144 may be embodied as any I/O device, such as human interface devices, keyboards, mice, touch screens, microphones, cameras, and other input devices, as well as displays and other output devices. As described above, the I/O controllers 142 and associated DMA channels are uniquely identified using identifiers called channel identifiers (CIDs). Each I/O controller 142 may assert an appropriate CID with every DMA transaction, for example as part of a transaction layer packet (TLP) prefix, to uniquely identify the source of the DMA transaction and provide liveness protections. The CID also enables the isolation of I/O from different devices 144.

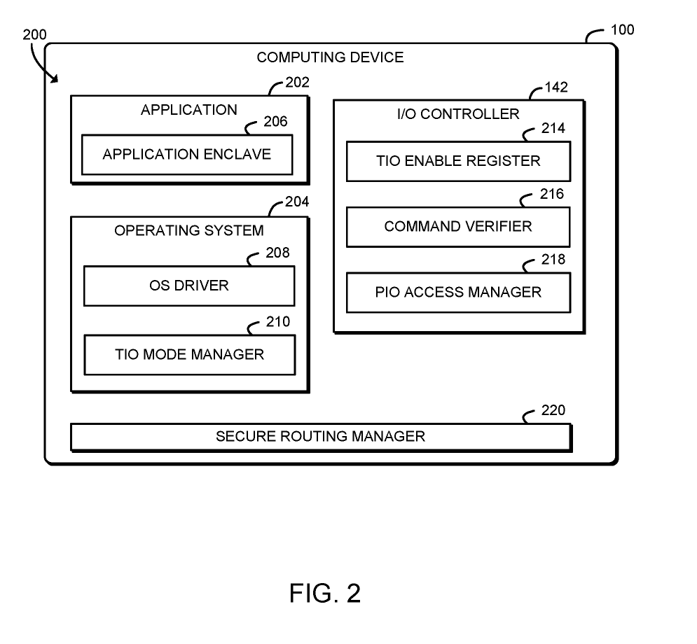

Referring now to FIG. 2, in an illustrative embodiment, the computing device 100 establishes an environment 200 during operation. The illustrative environment includes an application 202, an operating system 204, an I/O controller 142, and a secure routing manager 220. The application 202 includes an application enclave 206. The operating system 204 includes an OS driver 208 and a TIO mode manager 210. The I/O controller 142 includes a TIO enable register 214, a command verifier 216, and a PIO access manager 218. The various components of the environment 200 may be embodied as hardware, firmware, software, or a combination thereof. As such, in some embodiments, one or more of the components of the environment 200 may be embodied as circuitry or collection of electrical devices (e.g., application enclave circuitry 206, OS driver circuitry 208, TIO mode manager circuitry 210, command verifier circuitry 216, PIO access manager circuitry 218, and/or secure routing manager circuitry 220). It should be appreciated that, in such embodiments, one or more of the application enclave circuitry 206, the OS driver circuitry 208, the TIO mode manager circuitry 210, the command verifier circuitry 216, the PIO access manager circuitry 218, and/or the secure routing manager circuitry 220 may form a portion of the processor 120, the I/O subsystem 128, the I/O controller 142, and/or other components of the computing device 100. Additionally, in some embodiments, one or more of the illustrative components may form a portion of another component and/or one or more of the illustrative components may be independent of one another.

The application 202 is configured to load an application enclave 206 with the secure enclave support 122 of the processor 120. The application enclave 206 may be embodied as a trusted execution environment or other trusted software of the computing device 100, such as a secure enclave established with Intel SGX. As discussed above, code and/or data included in the secure enclave may be measured, verified, and/or otherwise determined to be authentic.

The operating system 204 may be embodied as any operating system, hypervisor, virtual machine monitor, and/or other executive component of the computing device 100 that manages hardware of the computing device 100 and otherwise controls runtime execution of the computing device 100. The operating system 204 further includes the OS driver 208 and the TIO mode manager 210. The OS driver 208 is configured to receive a secure session request from software (e.g., from the application enclave 206 that is being executed on the computing device 100) to establish a secure session (i.e., a trusted I/O channel) between the software and the I/O controller 142. The secure session between the requesting application and the I/O controller 142 may allow protecting I/O data transfers to and from an IO device via direct memory access. Additionally, the OS driver 208 may lock accesses to I/O controller 142 to ensure an exclusive access to the I/O controller 142 to execute the secure session request. Similarly, the OS driver 208 may also receive a secure session end request from the application enclave 206 to terminate the secure session and unlock accesses to I/O controller 142 to enable accesses to IO controller 142.

The TIO mode manager 210 is configured to program the I/O controller 142 to enable and/or disable trusted I/O functions of the I/O controller 142. Specifically, TIO mode manager 210 is configured to set or clear the TIO enable register 214 of the I/O controller 142. To do so, in the illustrative embodiment, the TIO mode manager 210 is configured to receive a command from microcode of the processor 120 to set or clear a TIO register bit of the TIO enable register 214 to change the TIO mode over the secured fabric 130. As discussed below, the secure routing manager 220 is configured to protect the TIO enable register 214 from unauthorized access using secure routing support of the computing device 100.

The command verifier 216 is configured to verify that a command to set or clear the TIO enable bit of the TIO enable register 214 is issued from microcode of the processor 120 of the computing device 100. It should be appreciated that, in the illustrative embodiment, only the microcode of the processor 120 can set or clear the TIO enable bit of the TIO enable register 214 in order to protect I/O data from modification by untrusted software. Alternatively, the trusted I/O may be disabled in response to a hardware reset of the computing device 100. However, it should be appreciated that the TIO mode is not affected by a soft reset of the computing device 100.

The PIO access manager 218 is configured to control accesses to one or more PIO registers of the I/O controller 142 based on the TIO mode of the I/O controller 142. For example, if the I/O controller 142 is in a TIO enabled mode, the PIO access manager 218 is configured to disable accesses to the memory regions associated with one or more PIO registers that allow access to plaintext I/O data to or from an I/O device. To do so, the PIO access manager 218 is configured to disable accesses to memory mapped I/O (MMIO) addresses associated with the one or more PIO registers. Additionally, the PIO access manager 218 may securely delete data in an I/O buffer in the I/O controller 142 in response to disabling the accesses to MMIO addresses to prevent any stale data stored in the I/O buffer from being transferred to the application over the secure fabric 130. Moreover, if the I/O controller 142 is in a TIO disabled mode, the PIO access manager 218 is configured to re-enable accesses to the memory regions associated with the PIO registers that were disabled during the TIO enabled mode. To do so, the PIO access manager 218 is configured to enable accesses to memory mapped I/O (MMIO) addresses associated with the PIO registers. Additionally, the PIO access manager 218 may securely delete data in the I/O buffer in the I/O controller in response to enabling the accesses to MMIO addresses to prevent a loss of the I/O data that was transferred during the TIO enabled mode.

The secure routing manager 220 is configured to control, by secure routing hardware of the computing device 100 such as the secure fabric 130, access to the memory region associated with the TIO enable register 214 that includes the TIO enable bit. Access may be controlled as a function of a security attribute of an initiator (SAI) of the access to the memory region. The SAI may include an identity of the initiator and/or a role of the initiator (e.g., software, microcode, or other role). Controlling access to the TIO enable register may include allowing read and write access to the TIO enable register only by the microcode of the processor 120. In some embodiments, controlling access to the TIO enable register may further include allowing only read access to the TIO enable register by a software component and denying write access to the TIO enable register by the software component. For example, the secure routing manager 220 is configured to transmit a command to set or clear the TIO enable register from the microcode to the I/O controller over the secure routing hardware. As discussed above, because the memory region associated with the TIO enable register is protected by hardware routing support, even privileged software such as an untrusted operating system may be prevented from modifying the TIO mode.

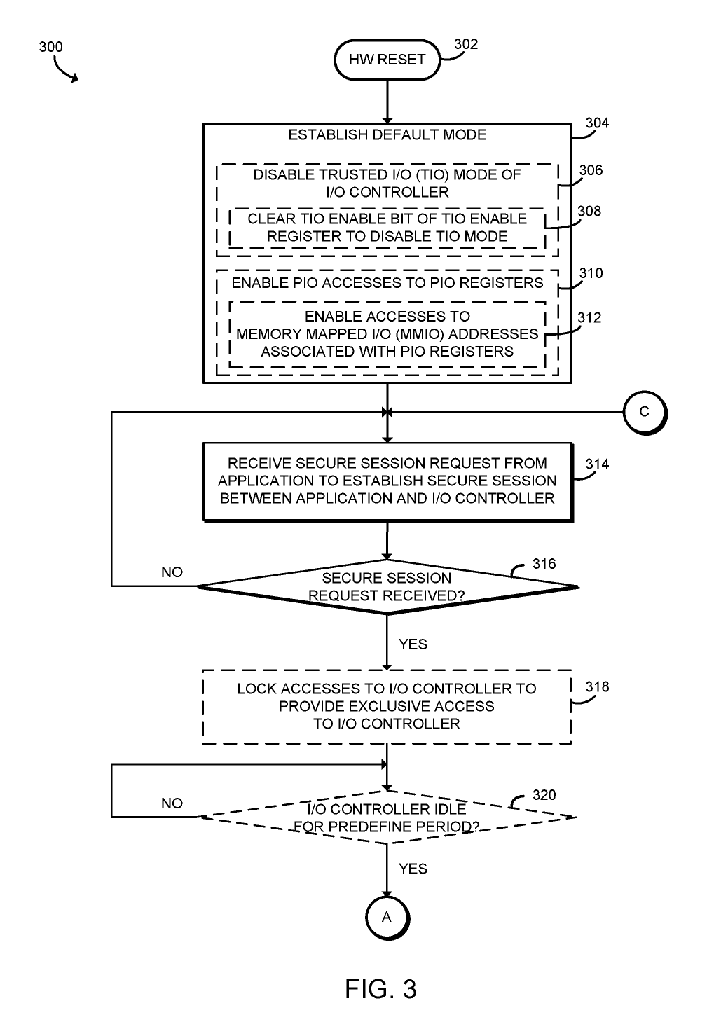

Referring now to FIGS. 3-5, in use, the computing device 100 may execute a method 300 for enabling an I/O controller 142 to securely transfer I/O data that may be performed by the computing device 100. In some embodiments, the operations of the method 300 may be performed by one or more components of the environment 200 of the computing device 100 as shown in FIG. 2. The method 300 begins in block 302, in which the computing device 100 performs a hardware reset. In response to the hardware reset, the computing device 100 establishes a default mode in block 304. In the default mode, the I/O controller 142 may allow programmed I/O (PIO) access to I/O data and disallow trusted I/O (TIO) data transfers. To do so, the computing device 100 may ensure that trusted I/O (TIO) operation is disabled in block 306. Specifically, the I/O controller 142 may clear a TIO enable bit of a TIO enable register 214 of the I/O controller 142 to ensure that the TIO is disabled as indicated in block 308. Additionally, in block 310 the I/O controller 142 may further ensure that programmable I/O (PIO) accesses to one or more PIO registers of the I/O controller 142 that allow access to plaintext I/O data to or from an I/O device 144 are enabled. To do so, the I/O controller 142 may enable accesses to memory mapped I/O (MMIO) addresses that are associated with one or more PIO registers of the I/O controller 142 to allow PIO accesses as indicated in block 312. As discussed above, the enablement of PIO accesses to the PIO registers allows software or applications that are being executed on the computing device 100 to read directly from or write directly into the PIO registers of the I/O controller 142. Accordingly, in the default mode, I/O data to or from the I/O devices 144 is not protected.

In block 314, the OS driver 208 of the computing device 100 receives a secure session request from an application that is being executed on the computing device 100 to establish a secure session (i.e., a trusted I/O channel) between the requesting application and the I/O controller 142. As discussed in detail below, the secure session between the requesting application and the I/O controller 142 only allows I/O data transfers via direct memory access to protect I/O data transferred to and from I/O devices. The application may include a secure enclave or other trusted execution environment capable of securely processing the I/O data.

If the computing device 100 determines that a secure session request has not been received in block 316, the method 300 loops back to block 314 to continue monitoring for a secure session request. If, however, the computing device 100 determines that a secure session request has been received in block 316, the method 300 advances to block 318.

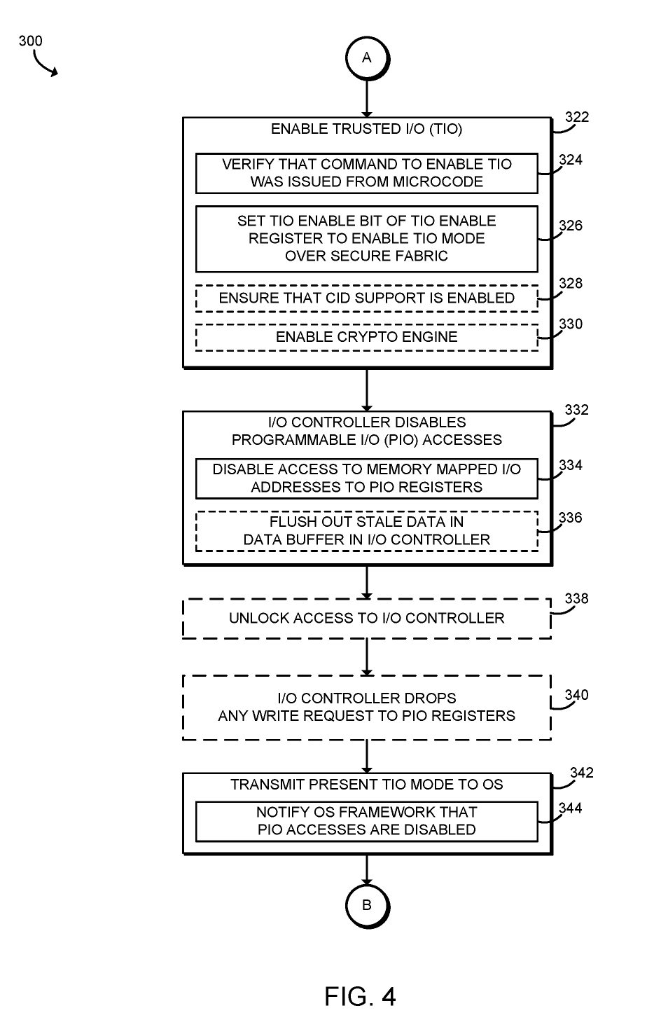

In some embodiments, in block 318 the OS driver 208 may lock accesses to I/O controller 142 to provide an exclusive access to the I/O controller 142 to establish an uninterrupted secure session. In some embodiments, the OS driver 208 may determine whether the I/O controller 142 is idle for a predefined time period as indicated in block 320. If the I/O controller 142 is not idle for the predefined time period, the method 300 loops back to block 320 to continue waiting until the I/O controller becomes idle for at least the predefined time period. If, however, the I/O controller 142 is idle for the predefined time period, the method 300 advances to block 322 shown in FIG. 4.

In block 322, the computing device 100 enables trusted I/O (TIO) operation for the I/O controller 142. In the illustrative embodiment, subsequent to receiving the secure session request, microcode of the processor 120 issues a command to set the TIO enable register 214 over the secure fabric 130 (i.e., the secure routing hardware) to establish the secure session. The processor 120 may issue the command, for example, in response to execution of a processor instruction such as UNWRAP. In response to receiving the command to set the TIO enable register 214, the I/O controller 142 verifies that the received command was issued from the microcode of the processor 120 of the computing device 100 as indicated in block 324. For example, the I/O controller 142 and/or secure routing hardware of the computing device 100 (e.g., the secure fabric 130) may verify a security attribute of the initiator (SAI) of the command to ensure that the received command was indeed issued from the microcode of the processor 120. The I/O controller 142 and/or the secure routing hardware may reject commands issued with a different SAI, for example rejecting commands issued by software executed by the processor 120. By doing so, the TIO enable register 214 may be protected from unauthorized access using secure routing support of the computing device 100.

In response to a verification that the command was issued from the microcode, the I/O controller 142 allows the processor 120 to set the TIO enable bit of the TIO enable register 214 of the I/O controller 142 to enable the TIO over the secure fabric 130 as indicated in block 326. In some embodiments, in block 328 the computing device 100 may ensures that the CID support is enabled to cause the I/O controller 142 to assert an appropriate CID with every trusted I/O DMA transaction to uniquely identify the specific I/O controller 142 and associated DMA channels to isolate the I/O from different I/O devices 144. The CID filter 132 may ensure that each trusted I/O DMA transaction is associated with a protected memory region associated with the particular CID (a CID TIO PRM). Additionally, in some embodiments, in block 330 the computing device 100 may enable the cryptographic engine 124 to intercept I/O data from trusted I/O devices to encrypt I/O data prior to transmitting the I/O data to the application.

In response to enabling TIO, in block 332 the I/O controller 142 disables PIO accesses to the memory regions associated with one or more PIO registers that allow access to plaintext I/O data to or from an I/O device. To do so, in block 334 the I/O controller 142 disables accesses to memory mapped I/O (MMIO) addresses associated with the those PIO registers of the I/O controller 142 to disable PIO accesses. It should be appreciated that some PIO registers, such as a PIO register that is responsible for enabling a power save mode, may not be disabled. In some embodiments, in block 336 the I/O controller 142 may securely flush out any data stored in an I/O buffer in the I/O controller 142 to prevent any stale data stored in the I/O buffer from being transferred to the application over the secure fabric 130.

In some embodiments, in block 338 the OS driver may unlock accesses to the I/O controller 142 that were locked in block 318. It should be appreciated that, even though accesses are unlocked, the I/O controller 142 has been programmed to enable TIO and prohibit any accesses to the PIO registers. Accordingly, in block 340 the I/O controller 142 may drop any write request to the PIO registers, without any indication of error. Additionally, the I/O controller 142 may return a predetermined value for any read from such PIO registers (e.g., all 1's or other non-sensitive value). This ensures that the PIO registers of the I/O controller are not being accessed and only direct memory access is allowed during the TIO enabled mode.

Additionally, in block 342 the I/O controller 142 transmits the present TIO mode to the operating system (OS) 204, such that the OS 204 is aware the I/O controller 142 is in the TIO enabled mode. In other words, the I/O controller 142 notifies the OS framework of the present TIO mode, such that other applications that are being executed on the computing device 100 are aware that accesses to the memory regions of a memory 136 associated with the PIO registers of the I/O controller 142 that allow access to plaintext I/O data to or from an I/O device are disabled as indicated in block 344.

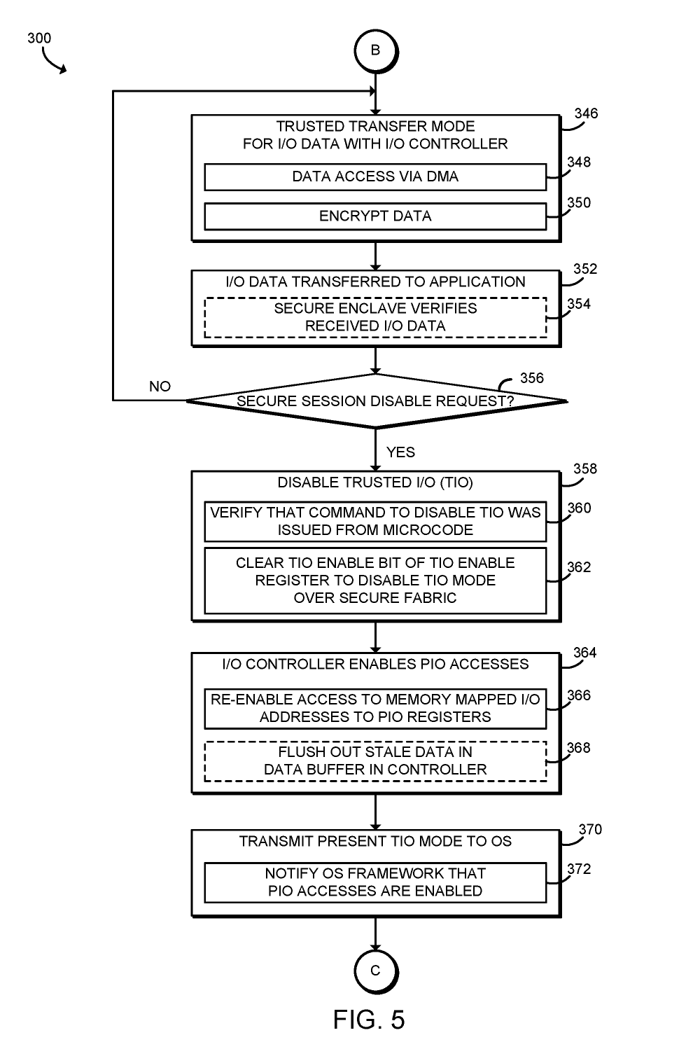

Subsequently, in block 346 shown in FIG. 5, the I/O controller 142 is in a trusted transfer mode to securely transfer I/O data between an I/O device 144 and the requesting application. To do so, the I/O data is transferred to or from the I/O device 144 via direct memory access (DMA) as indicated in block 348. This allows the cryptographic engine 124 to securely copy and encrypt I/O data to or from the I/O device 144 to the I/O buffer prior to transmitting to the requesting application as indicated in block 350. In some embodiments, a processor-based cryptographic engine 124 may copy and encrypt the I/O data from the CID TIO PRM into an ordinary kernel buffer. The encrypted I/O data is then securely transferred to the requested application as indicated in block 352. It should be appreciated that the I/O data transfers are thus protected by the trusted I/O channel. In some embodiment, in block 354 the secure enclave support 122 may verify the received I/O data to ensure that the I/O data is from the trusted I/O device 144.

In block 356, the computing device 100 determines whether a secure session disable request has been received from the application. If the secure session disable request has not been received, the method 300 loops back to block 344 to continue performing in the trusted transfer mode. If, however, the secure session disable request has been received, the method 300 advances to block 358. It should be appreciated that, in some embodiments, the computing device 100 may determine to terminate the secure session (i.e., to disable the TIO mode) in response to a completion of the I/O data transfers.

In block 358, the computing device 100 disables the TIO operation for the I/O controller 142. In the illustrative embodiment, subsequent to receiving the secure session disable request, the microcode of the processor 120 issues a command to clear the TIO enable register 214 over the secure fabric 130 (i.e., the secure routing hardware) to terminate the secure session. The processor 120 may issue the command, for example, in response to execution of a processor instruction such as UNWRAP. In response to receiving the command to clear the TIO enable register 214, the I/O controller 142 again verifies that a command to disable the TIO was issued from the microcode of the processor 120 as indicated in block 360. For example, as discussed above, the I/O controller 142 and/or secure routing hardware of the computing device 100 (e.g., the secure fabric 130) may verify a security attribute of the initiator (SAI) of the command to ensure that the received command was indeed issued from the microcode of the processor 120. The I/O controller 142 and/or the secure routing hardware may reject commands issued with a different SAI, for example rejecting commands issued by software executed by the processor 120. By doing so, the TIO enable register 214 may be protected from unauthorized access using secure routing support of the computing device 100. In response to a verification that the command was issued from the microcode, the processor 120 clears the TIO enable bit of the TIO enable register 214 of the I/O controller 142 to disable the TIO over the secure fabric 130 as indicated in block 362. Note that, in order to protect the security of any secure sessions, the TIO enable bit is not resettable through a software reset register. The TIO enable bit may only be reset with a hardware reset (which causes the I/O controller 142 to enter the default mode as described above in connection with FIG. 3) or by programming with a command to clear the TIO enable bit as described herein.

In response to disabling TIO, in block 364 the I/O controller 142 enables PIO accesses. To do so, in block 366 the I/O controller 142 re-enables accesses to the memory mapped I/O (MMIO) addresses associated with the PIO registers that were disabled in block 334. In some embodiments, in block 338, the I/O controller 142 may securely flush out any I/O data stored in an I/O buffer in the I/O controller 142 to prevent a loss of the I/O data that was transferred during the TIO.

Additionally, in block 370, the I/O controller 142 transmits the present TIO mode to the operating system (OS) 204, such that the OS 204 is aware the I/O controller 142 is in the TIO disabled mode. In other words, the I/O controller 142 notifies the OS framework, such that other applications that are being executed on the computing device 100 are aware, that accesses to the memory regions of a memory 136 associated with the PIO registers of the I/O controller 142 are enabled as indicated in block 372. Subsequently, the method 300 loops back to block 314 to continue monitoring for a secure session request from an application.

It should be appreciated that, in some embodiments, the method 300 may be embodied as various instructions stored on a computer-readable media, which may be executed by the processor 120, the I/O subsystem 128, the I/O controller 142, and/or other components of the computing device 100 to cause the computing device 100 to perform the method 300. The computer-readable media may be embodied as any type of media capable of being read by the computing device 100 including, but not limited to, the memory 136, the data storage device 138, firmware devices, other memory or data storage devices of the computing device 100, portable media readable by a peripheral device of the computing device 100, and/or other media.

### EXAMPLES

Illustrative examples of the technologies disclosed herein are provided below. An embodiment of the technologies may include any one or more, and any combination of, the examples described below.

Example 1 includes a computing device for secure I/O, the computing device comprising an I/O controller; and a trusted I/O (TIO) mode manager to program, over a secure routing hardware of the computing device, the I/O controller of the computing device to allow or disallow trusted I/O; wherein the I/O controller is to disable accesses to memory regions associated with one or more programmable I/O registers of an I/O controller of the computing device in response to programming the I/O controller to allow trusted I/O; perform I/O data transfers to or from an I/O device via direct memory access in response to disabling the accesses to the memory regions associated with the one or more programmable I/O registers, wherein the I/O data transfers are protected by a trusted I/O channel; and enable accesses to the address regions associated with the one or more programmable I/O registers in response to programming the I/O controller to disallow trusted I/O.

Example 2 includes the subject matter of Example 1, and wherein the TIO mode manager is further to receive a secure session request from an application executed by the computing device to establish a secure session between the application and the I/O controller; and wherein to program the I/O controller to allow trusted I/O comprises to program the I/O controller to allow trusted I/O in response to a receipt of the secure session request.

Example 3 includes the subject matter of any of Examples 1 and 2, and wherein the application comprises a trusted execution environment established by secure enclave support of a processor of the computing device.

Example 4 includes the subject matter of any of Examples 1-3, and further including an OS driver to lock, in response to a receipt of the secure session request, accesses to the I/O controller.

Example 5 includes the subject matter of any of Examples 1-4, and further including a secure routing manager to control accesses to a trusted I/O (TIO) enable register of the I/O controller that is to enable or disable accesses to the memory regions associated with the one or more programmable I/O registers.

Example 6 includes the subject matter of any of Examples 1-5, and wherein the TIO enable register is access restricted to microcode of a CPU of the computing device.

Example 7 includes the subject matter of any of Examples 1-6, and wherein to program the I/O controller of the computing device to allow trusted I/O comprises to set the TIO enable register over the secure routing hardware.

Example 8 includes the subject matter of any of Examples 1-7, and wherein to set the TIO enable register comprises to route a command that sets the TIO enable register over the secure routing hardware to the I/O controller; and verify, by the secure routing hardware, a security attribute of the initiator (SAI) of the command to ensure that the command is issued from microcode of the computing device.

Example 9 includes the subject matter of any of Examples 1-8, and wherein to program the I/O controller of the computing device to disallow trusted I/O comprises to clear the TIO enable register over the secure routing hardware.

Example 10 includes the subject matter of any of Examples 1-9, and wherein to clear the TIO enable register comprises to route a command that clears the TIO enable register over the secure routing hardware to the I/O controller; and verify, by the secure routing hardware, a security attribute of the initiator (SAI) of the command to ensure that the command is issued from microcode of the computing device.

Example 11 includes the subject matter of any of Examples 1-10, and wherein the I/O controller is further to transmit, in response to programming the I/O controller to allow the trusted I/O, a controller state of the I/O controller to an operating system of the computing device.

Example 12 includes the subject matter of any of Examples 1-11, and wherein the programmable I/O registers comprises a register that allows access to plaintext I/O data to or from an I/O device.

Example 13 includes the subject matter of any of Examples 1-12, and wherein the I/O controller is further to drop a write request to the address regions associated with the one or more programmable I/O registers in response to disabling the accesses to memory regions associated with one or more programmable I/O registers.

Example 14 includes the subject matter of any of Examples 1-13, and wherein to disable the accesses to the memory regions associated with one or more programmable I/O registers comprises to disable accesses to memory mapped I/O addresses associated with the one or more programmable I/O registers.

Example 15 includes the subject matter of any of Examples 1-14, and wherein the I/O controller is further to securely delete data in an I/O buffer in the I/O controller in response to disabling the accesses to memory mapped I/O addresses.

Example 16 includes the subject matter of any of Examples 1-12, and to perform the I/O data transfers to or from the I/O device comprises to perform the I/O data transfers to the I/O device by encrypting I/O data using a cryptographic engine of the computing device where the I/O data is transferred to a trusted I/O processor reserved memory (TIO PRM) region.

Example 17 includes the subject matter of any of Examples 1-13, and to perform I/O data transfers from the I/O device comprises to verify, by an application that requested the I/O data, integrity of the I/O data.

Example 18 includes the subject matter of any of Examples 1-13, and to enable the accesses to the memory regions associated with one or more programmable I/O registers comprises to enable accesses to memory mapped I/O addresses associated with the one or more programmable I/O registers.

Example 19 includes the subject matter of any of Examples 1-18, and wherein the I/O controller is further to securely delete data in an I/O buffer in the I/O controller in response to enabling the accesses to memory mapped I/O addresses.

Example 20 includes the subject matter of any of Examples 1-13, and the I/O controller is further to establish a default mode by enabling accesses to the memory regions associated with the one or more programmable I/O registers in response to a hardware reset of the computing device.

Example 21 includes a method for secure I/O, the method comprising programming, by a secure routing hardware of a computing device, an I/O controller of the computing device to allow trusted I/O; disabling, by the I/O controller, accesses to memory regions associated with one or more programmable I/O registers of an I/O controller of the computing device in response to programming the I/O controller to allow trusted I/O; performing, by the I/O controller, I/O data transfers to or from an I/O device via direct memory access in response to disabling the accesses to the memory regions associated with the one or more programmable I/O registers, wherein the I/O data transfers are protected by a trusted I/O channel; programming, by a secure routing hardware, the I/O controller to disallow the trusted I/O; and enabling, by the I/O controller, accesses to the address regions associated with the one or more programmable I/O registers in response to programming the I/O controller to disallow trusted I/O.

Example 22 includes the subject matter of Example 21, and further including receiving, by the I/O controller, a secure session request from an application executed by the computing device to establish a secure session between the application and the I/O controller; wherein programming the I/O controller to allow trusted I/O comprises programming, by the secure routing hardware, the I/O controller to allow trusted I/O in response to a receipt of the secure session request.

Example 23 includes the subject matter of any of Examples 21 and 22, and wherein the application comprises a trusted execution environment established by secure enclave support of a processor of the computing device.

Example 24 includes the subject matter of any of Examples 21-23, and further including locking, in response to a receipt of the secure session request and by an OS driver of the computing device, accesses to the I/O controller.

Example 25 includes the subject matter of any of Examples 21-24, and further including controlling, by the secure routing hardware of the computing device, accesses to a trusted I/O (TIO) enable register of the I/O controller that is to enable or disable accesses to the memory regions associated with the one or more programmable I/O registers.

Example 26 includes the subject matter of any of Examples 21-25, and wherein the TIO enable register is access restricted to microcode of a CPU of the computing device.

Example 27 includes the subject matter of any of Examples 21-26, and wherein programming the I/O controller of the computing device to allow trusted I/O comprises setting, by the computing device, the TIO enable register over the secure routing hardware.

Example 28 includes the subject matter of any of Examples 21-27, and wherein setting the TIO enable register comprises routing, by the computing device, a command that sets the TIO enable register over the secure routing hardware to the I/O controller; and verifying, by the secure routing hardware, a security attribute of the initiator (SAI) of the command to ensure that the command is issued from microcode of the computing device.

Example 29 includes the subject matter of any of Examples 21-28, and wherein programming the I/O controller of the computing device to disallow trusted I/O comprises clearing, by the computing device, the TIO enable register over the secure routing hardware.

Example 30 includes the subject matter of any of Examples 21-29, and wherein clearing the TIO enable register comprises routing, by the computing device, a command that clears the TIO enable register over the secure routing hardware to the I/O controller; and verifying, by the secure routing hardware, a security attribute of the initiator (SAI) of the command to ensure that the command is issued from microcode of the computing device.

Example 31 includes the subject matter of any of Examples 21-30, and further including transmitting, in response to programming the I/O controller to allow the trusted I/O and by the I/O controller, a controller state of the I/O controller to an operating system of the computing device.

Example 32 includes the subject matter of any of Examples 21-31, and wherein the programmable I/O registers comprises a register that allows access to plaintext I/O data to or from an I/O device.

Example 33 includes the subject matter of any of Examples 21-32, and further including dropping, by the I/O controller, a write request to the address regions associated with the one or more programmable I/O registers in response to disabling the accesses to memory regions associated with one or more programmable I/O registers.

Example 34 includes the subject matter of any of Examples 21-33, and wherein disabling the accesses to the memory regions associated with one or more programmable I/O registers comprises disabling, by the I/O controller, accesses to memory mapped I/O addresses associated with the one or more programmable I/O registers.

Example 35 includes the subject matter of any of Examples 21-34, and further including securely deleting, by the I/O controller, data in an I/O buffer in the I/O controller in response to disabling the accesses to memory mapped I/O addresses.

Example 36 includes the subject matter of any of Examples 21-35, and wherein performing the I/O data transfers to or from the I/O device comprises performing the I/O data transfers to the I/O device by encrypting I/O data using a cryptographic engine of the computing device where the I/O data is transferred to a trusted I/O processor reserved memory (TIO PRM) region.

Example 37 includes the subject matter of any of Examples 21-36, and wherein performing the I/O data transfers comprises verifying, by an application that requested the I/O data, integrity of the I/O data.

Example 38 includes the subject matter of any of Examples 21-37, and wherein enabling the accesses to the memory regions associated with one or more programmable I/O registers comprises enabling, by the I/O controller, accesses to memory mapped I/O addresses associated with the one or more programmable I/O registers.

Example 39 includes the subject matter of any of Examples 21-38, and further including securely deleting, by the I/O controller, data in an I/O buffer in the I/O controller in response to enabling the accesses to memory mapped I/O addresses.

Example 40 includes the subject matter of any of Examples 21-39, and further including establishing, by the I/O controller, a default mode by enabling accesses to the memory regions associated with the one or more programmable I/O registers in response to a hardware reset of the computing device.

Example 41 includes a computing device comprising a processor; and a memory having stored therein a plurality of instructions that when executed by the processor cause the computing device to perform the method of any of Examples 21-40.

Example 42 includes one or more non-transitory, computer readable storage media comprising a plurality of instructions stored thereon that in response to being executed result in a computing device performing the method of any of Examples 21-40.

Example 43 includes a computing device comprising means for performing the method of any of Examples 21-40.

Example 44 includes a computing device for secure I/O, the computing device comprising means for programming an I/O controller of the computing device to allow trusted I/O; means for disabling accesses to memory regions associated with one or more programmable I/O registers of an I/O controller of the computing device in response to programming the I/O controller to allow trusted I/O; means for performing I/O data transfers to or from an I/O device via direct memory access in response to disabling the accesses to the memory regions associated with the one or more programmable I/O registers, wherein the I/O data transfers are protected by a trusted I/O channel; means for programming the I/O controller to disallow the trusted I/O; and means for enabling accesses to the address regions associated with the one or more programmable I/O registers in response to programming the I/O controller to disallow trusted I/O.

Example 45 includes the subject matter of Example 44, and further including means for receiving a secure session request from an application executed by the computing device to establish a secure session between the application and the I/O controller; wherein the means for programming the I/O controller to allow trusted I/O comprises means for programming the I/O controller to allow trusted I/O in response to a receipt of the secure session request.

Example 46 includes the subject matter of any of Examples 44 and 45, and wherein the application comprises a trusted execution environment established by secure enclave support of a processor of the computing device.

Example 47 includes the subject matter of any of Examples 44-46, and further including means for locking, in response to a receipt of the secure session request, accesses to the I/O controller.

Example 48 includes the subject matter of any of Examples 44-47, and further including means for controlling accesses to a trusted I/O (TIO) enable register of the I/O controller that is to enable or disable accesses to the memory regions associated with the one or more programmable I/O registers.

Example 49 includes the subject matter of any of Examples 44-48, and wherein the TIO enable register is access restricted to microcode of a CPU of the computing device.

Example 50 includes the subject matter of any of Examples 44-49, and wherein the means for programming the I/O controller of the computing device to allow trusted I/O comprises means for setting the TIO enable register over the secure routing hardware.

Example 51 includes the subject matter of any of Examples 44-50, and wherein the means for setting the TIO enable register comprises means for routing a command that sets the TIO enable register over a secure routing hardware to the I/O controller; and means for verifying a security attribute of the initiator (SAI) of the command to ensure that the command is issued from microcode of the computing device.

Example 52 includes the subject matter of any of Examples 44-51, and wherein the means for programming the I/O controller of the computing device to disallow trusted I/O comprises means for clearing the TIO enable register over the secure routing hardware.

Example 53 includes the subject matter of any of Examples 44-52, and wherein the means for clearing the TIO enable register comprises means for routing a command that clears the TIO enable register over a secure routing hardware to the I/O controller; and means for verifying a security attribute of the initiator (SAI) of the command to ensure that the command is issued from microcode of the computing device.

Example 54 includes the subject matter of any of Examples 44-53, and further including means for transmitting, in response to programming the I/O controller to allow the trusted I/O, a controller state of the I/O controller to an operating system of the computing device.

Example 55 includes the subject matter of any of Examples 44-54, and wherein the programmable I/O registers comprises a register that allows access to plaintext I/O data to or from an I/O device.

Example 56 includes the subject matter of any of Examples 44-55, and further including means for dropping a write request to the address regions associated with the one or more programmable I/O registers in response to disabling the accesses to memory regions associated with one or more programmable I/O registers.

Example 57 includes the subject matter of any of Examples 44-56, and wherein the means for disabling the accesses to the memory regions associated with one or more programmable I/O registers comprises means for disabling accesses to memory mapped I/O addresses associated with the one or more programmable I/O registers.

Example 58 includes the subject matter of any of Examples 44-57, and further including means for securely deleting data in an I/O buffer in the I/O controller in response to disabling the accesses to memory mapped I/O addresses.

Example 59 includes the subject matter of any of Examples 44-58, and wherein the means for performing the I/O data transfers to or from the I/O device comprises means for performing the I/O data transfers to the I/O device by encrypting I/O data using a cryptographic engine of the computing device where the I/O data is transferred to a trusted I/O processor reserved memory (TIO PRM) region.

Example 60 includes the subject matter of any of Examples 44-59, and wherein the means for performing the I/O data transfers comprises means for verifying, by an application that requested the I/O data, integrity of the I/O data.

Example 61 includes the subject matter of any of Examples 44-60, and wherein the means for enabling the accesses to the memory regions associated with one or more programmable I/O registers comprises means for enabling accesses to memory mapped I/O addresses associated with the one or more programmable I/O registers.

Example 62 includes the subject matter of any of Examples 44-61, and further including means for securely deleting data in an I/O buffer in the I/O controller in response to enabling the accesses to memory mapped I/O addresses.

Example 63 includes the subject matter of any of Examples 44-62, and further including means for establishing, by the I/O controller, a default mode by enabling accesses to the memory regions associated with the one or more programmable I/O registers in response to a hardware reset of the computing device.

1. A computing device for secure I/O, the computing device comprising:
an I/O controller; and
a trusted I/O (TIO) mode manager to program, over a secure routing hardware of the computing device, the I/O controller of the computing device to allow or disallow trusted I/O;
wherein the I/O controller is to:
disable accesses to memory regions associated with one or more programmable I/O registers of an I/O controller of the computing device in response to programming the I/O controller to allow trusted I/O;
perform I/O data transfers to or from an I/O device via direct memory access in response to disabling the accesses to the memory regions associated with the one or more programmable I/O registers, wherein the I/O data transfers are protected by a trusted I/O channel; and
enable accesses to the address regions associated with the one or more programmable I/O registers in response to programming the I/O controller to disallow trusted I/O.

2. The computing device of claim 1, wherein the TIO mode manager is further to receive a secure session request from an application executed by the computing device to establish a secure session between the application and the I/O controller; and
wherein to program the I/O controller to allow trusted I/O comprises to program the I/O controller to allow trusted I/O in response to a receipt of the secure session request.

3. The computing device of claim 1, further comprising a secure routing manager to control accesses to a trusted I/O (TIO) enable register of the I/O controller that is to enable or disable accesses to the memory regions associated with the one or more programmable I/O registers.

4. The computing device of claim 3, wherein the TIO enable register is access restricted to microcode of a CPU of the computing device.

5. The computing device of claim 3, wherein to program the I/O controller of the computing device to allow trusted I/O comprises to set the TIO enable register over the secure routing hardware.

6. The computing device of claim 5, wherein to set the TIO enable register comprises to:
route a command that sets the TIO enable register over the secure routing hardware to the I/O controller; and
verify, by the secure routing hardware, a security attribute of the initiator (SAI) of the command to ensure that the command is issued from microcode of the computing device.

7. The computing device of claim 3, wherein to program the I/O controller of the computing device to disallow trusted I/O comprises to clear the TIO enable register over the secure routing hardware.

8. The computing device of claim 7, wherein to clear the TIO enable register comprises to:
route a command that clears the TIO enable register over the secure routing hardware to the I/O controller; and
verify, by the secure routing hardware, a security attribute of the initiator (SAI) of the command to ensure that the command is issued from microcode of the computing device.

9. The computing device of claim 1, wherein the I/O controller is further to transmit, in response to programming the I/O controller to allow the trusted I/O, a controller state of the I/O controller to an operating system of the computing device.

10. The computing device of claim 1, wherein the I/O controller is further to drop a write request to the address regions associated with the one or more programmable I/O registers in response to disabling the accesses to memory regions associated with one or more programmable I/O registers.

11. The computing device of claim 1, wherein to disable the accesses to the memory regions associated with one or more programmable I/O registers comprises to disable accesses to memory mapped I/O addresses associated with the one or more programmable I/O registers.

12. The computing device of claim 1, wherein to perform the I/O data transfers to or from the I/O device comprises to perform the I/O data transfers to the I/O device by encrypting I/O data using a cryptographic engine of the computing device where the I/O data is transferred to a trusted I/O processor reserved memory (TIO PRM) region.

13. The computing device of claim 1, wherein to enable the accesses to the memory regions associated with one or more programmable I/O registers comprises to enable accesses to memory mapped I/O addresses associated with the one or more programmable I/O registers.

14. The computing device of claim 1, wherein the I/O controller is further to establish a default mode by enabling accesses to the memory regions associated with the one or more programmable I/O registers in response to a hardware reset of the computing device.

15. One or more machine-readable storage media comprising a plurality of instructions stored thereon that, in response to being executed, cause a computing device to:
program an I/O controller of the computing device to allow trusted I/O;
disable accesses to memory regions associated with one or more programmable I/O registers of an I/O controller of the computing device in response to programming the I/O controller to allow trusted I/O;
perform I/O data transfers to or from an I/O device via direct memory access in response to disabling the accesses to the memory regions associated with the one or more programmable I/O registers, wherein the I/O data transfers are protected by a trusted I/O channel;
program the I/O controller to disallow the trusted I/O; and
enable accesses to the address regions associated with the one or more programmable I/O registers in response to programming the I/O controller to disallow trusted I/O.

16. The one or more machine-readable storage media of claim 15, further comprising a plurality of instructions that in response to being executed cause the computing device to receive a secure session request from an application executed by the computing device to establish a secure session between the application and the I/O controller; and
wherein to program the I/O controller to allow trusted I/O comprises to program the I/O controller to allow trusted I/O in response to a receipt of the secure session request.

17. The one or more machine-readable storage media of claim 15, further comprising a plurality of instructions that in response to being executed cause the computing device to control accesses to a trusted I/O (TIO) enable register of the I/O controller that is to enable or disable accesses to the memory regions associated with the one or more programmable I/O registers.

18. The one or more machine-readable storage media of claim 17, wherein to program the I/O controller of the computing device to allow trusted I/O comprises to set the TIO enable register over the secure routing hardware.

19. The one or more machine-readable storage media of claim 18, wherein to set the TIO enable register comprises to:
route a command that sets the TIO enable register over the secure routing hardware to the I/O controller; and
verify a security attribute of the initiator (SAI) of the command to ensure that the command is issued from microcode of the computing device.

20. The one or more machine-readable storage media of claim 17, wherein to program the I/O controller of the computing device to disallow trusted I/O comprises to clear the TIO enable register over the secure routing hardware.

21. The one or more machine-readable storage media of claim 20, wherein to clear the TIO enable register comprises to:
route a command that clears the TIO enable register over the secure routing hardware to the I/O controller; and
verify a security attribute of the initiator (SAI) of the command to ensure that the command is issued from microcode of the computing device.

22. A method for secure I/O, the method comprising:
programming, by a secure routing hardware of a computing device, an I/O controller of the computing device to allow trusted I/O;
disabling, by the I/O controller, accesses to memory regions associated with one or more programmable I/O registers of an I/O controller of the computing device in response to programming the I/O controller to allow trusted I/O;
performing, by the I/O controller, I/O data transfers to or from an I/O device via direct memory access in response to disabling the accesses to the memory regions associated with the one or more programmable I/O registers, wherein the I/O data transfers are protected by a trusted I/O channel;
programming, by a secure routing hardware, the I/O controller to disallow the trusted I/O; and
enabling, by the I/O controller, accesses to the address regions associated with the one or more programmable I/O registers in response to programming the I/O controller to disallow trusted I/O.

23. The method of claim 22 further comprising receiving, by the I/O controller, a secure session request from an application executed by the computing device to establish a secure session between the application and the I/O controller;
wherein programming the I/O controller to allow trusted I/O comprises programming, by the secure routing hardware, the I/O controller to allow trusted I/O in response to a receipt of the secure session request.

24. The method of claim 22 further comprising controlling, by the secure routing hardware of the computing device, accesses to a trusted I/O (TIO) enable register of the I/O controller that is to enable or disable accesses to the memory regions associated with the one or more programmable I/O registers.

25. The method of claim 24, wherein programming the I/O controller of the computing device to allow trusted I/O comprises setting, by the computing device, the TIO enable register over the secure routing hardware.
